(19) United States
(12) Patent Application Publication
(10) Pub. No.: US 2010/0062336 A1
(43) Pub. Date: Mar. 11, 2010

(54) PLASTICIZED ELECTRODE FOR AN ALKALINE BATTERY

(75) Inventors: Patrick Bernard, Bordeaux (FR); Lionel Goubault, Carigan de Bordeaux (FR)

Correspondence Address: SUGHRUE MION, PLLC, 2100 PENNSYLVANIA AVENUE, N.W., SUITE 800, WASHINGTON, DC, 20037, US

(73) Assignee: SAFT GROUPE SA, Bagnolet (FR)

(21) Appl. No.: 12/440,566

(22) PCT Filed: Sep. 11, 2007
(86) PCT No.: PCT/FR07/01460

§ 371 Date: Nov. 12, 2009

(30) Foreign Application Priority Data
Sep. 15, 2006 (FR) 06 08 092

(51) Int. Cl. H01M 4/62

(52) U.S. Cl. 429/217

(57) ABSTRACT

An electrode comprising a metallic conductive support and a paste comprising an electrochemically active substance and a binder; the binder comprising at least one ethylene-vinyl acetate copolymer in a proportion by weight of at least approximately 0.25% relative to the weight of said paste, the binder comprising neither polystyrene nor butadiene copolymer. An alkaline-electrolyte battery comprising such an electrode.

### TECHNICAL FIELD

The present invention relates to a plasticized electrode for an alkaline electrolyte battery, such as for example a nickel-cadmium (NiCd) or nickel metal hydride (NiMH) battery. It also includes the battery containing such an electrode.

### STATE OF THE ART

Several types of electrodes exist which are capable of being used in an alkaline electrolyte battery, such as sintered electrodes and non-sintered electrodes. Compared to the other types of electrodes, a non-sintered electrode contains a larger quantity of material, its volumic capacity is therefore increased and its production costs are reduced.

A non-sintered electrode is composed of a support serving as a current collector, which is coated with a paste containing the active material and a binder, to which a conductive material is generally added. Once the paste is deposited on or in the support, the whole is compressed and dried in order to obtain an electrode of the desired density and thickness.

Among the non-sintered electrodes, the nickel foam type electrode which has a three-dimensional support, and the plasticized electrode which has a support in the form of a strip of perforated metal or of expanded metal, are distinguished.

An analysis of the costs per component of a conventional NiMH battery shows that the substrate of the positive electrode, of the nickel foam type, therefore three-dimensional, represents more than 50% of the cost of the current electrode. Extending NiMH technology to applications such as the hybrid electric vehicle requires significant cost reductions for the batteries.

This is why the use of a two-dimensional support is sometimes preferred to that of a three-dimensional conductor.

The cohesion of the active material and its adherence to the two-dimensional support are generally improved by the addition of a binder. This binder can be a styrene acrylate copolymer. Positive electrodes with plasticized technology comprising a binder based on styrene acrylate have been developed. This binder is not stable at the voltage of the positive electrode. It undergoes an oxidation reaction which generates in parallel a reduction reaction at the negative electrode. As a result, the oxidation of the binder leads to a reduction of the excess negative capacity proportional to the quantity of electrons generated by the oxidation reaction of the binder. When the excess negative capacity becomes zero, the negative electrode generates gaseous hydrogen during the charging step of the battery, the pressure in the battery increases until to the opening of the safety valve. Drying follows and the end of the life of the battery.

The article published in Journal of The Electrochemical Society (152 (5) A905-A912 (2005)) discloses a positive electrode of a nickel metal hydride battery comprising a three-dimensional nickel plated steel strip and a binder of the styrene acrylate type. However the life of this battery is 1000 cycles at 25° C. and only 180 cycles at 45° C. due to decomposition of the styrene acrylate.

An alkaline battery is therefore sought comprising a plasticized positive electrode and having an improved life cycle and/or calendar life.

### SUMMARY OF THE INVENTION

The invention relates to an electrode comprising a conductive metallic support and a paste comprising an electrochemically-active material and a binder;
the binder comprising at least one ethylene-vinyl acetate copolymer in a proportion by weight of at least approximately 0.25% with respect to the weight of said paste,
the binder comprising neither polystyrene nor butadiene copolymer.

The invention includes an alkaline electrolyte battery comprising such an electrode.

The use of the ethylene-vinyl acetate copolymer improves the life cycle of the battery and/or calendar life.

According to an embodiment, the ethylene-vinyl acetate copolymer represents at least 30%, preferably at least 50%, preferably at least 75%, preferably also at least 80%, preferably also at least 90%, preferably also at least 95% of the weight of the binder.

According to an embodiment, the percentage by weight of the vinyl acetate group represents 10-95%, preferably 50-95%, preferably also 70-90% of the weight of the ethylene-vinyl acetate copolymer.

According to an embodiment, the ethylene-vinyl acetate copolymer represents 0.25-1% by weight, preferably 0.25-0.8% by weight, preferably also 0.25-0.5% by weight of the weight of said paste.

According to an embodiment, the binder contains a fluorinated polymer which can be polytetrafluoroethylene.

According to an embodiment, the binder contains a polymer with an acrylate function, which can be chosen from the group comprising a styrene-acrylate copolymer, a poly(meth)acrylate, a styrene-maleic anhydride copolymer.

According to an embodiment, the binder contains a compound of the silane type.

According to an embodiment, the electrode also comprises fibres which can be polypropylene fibres.

According to an embodiment, the quantity of fibres added is less than approximately 1.5% of the weight of the paste.

According to an embodiment, the conductive metal support is two-dimensional.

According to an embodiment, the electrode is the positive electrode of an alkaline battery.

According to an embodiment, the electrochemically-active material is a nickel hydroxide-based compound.

According to an embodiment, the electrode is the negative electrode of an alkaline battery.

The invention also proposes an electrode comprising a conductive metal support and a paste comprising an electrochemically-active material and a binder;
the binder comprising at least one ethylene-vinyl acetate copolymer in a proportion by weight of approximately 0.25% to 1% with respect to the weight of said paste,
the ethylene-vinyl acetate copolymer representing at least 80% of the weight of the binder.

The binder according to the invention is advantageously used for pasted (non-sintered) electrodes which have a lower mechanical cohesion than a sintered electrode. The mechanical performance of a sintered electrode is linked to its structure which contains a large quantity of sintered nickel. This technology does not require a binder to ensure the mechanical performance of the electrode.

### DETAILED DISCLOSURE OF EMBODIMENTS OF THE INVENTION

The electrode according to the invention is produced by depositing a paste comprising the binder according to the invention and the active material on a current collector. Advantageously, before application onto the current collector, an electronic conductor, one or more thickening agents and fibres are added to this paste. These different constituents will now be described.

The binder is the constituent of the paste which characterizes the invention. This binder comprises at least one ethylene-vinyl acetate (EVA) copolymer. It can also comprise a mixture of ethylene-vinyl acetate copolymers.

An ethylene-vinyl acetate copolymer can be represented by the following general formula:

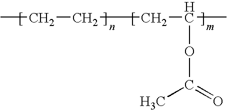

in which:

—CH₂—CH₂— represents an ethylene group,

—CH₂—CHOCOCH₃— represents a vinyl acetate group.

Another example of ethylene-vinyl acetate copolymer is the ethylene-vinyl acetate-maleic anhydride terpolymer represented by the following general formula:

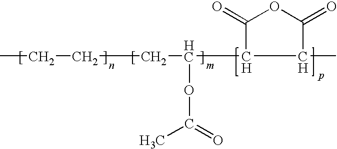

According to an embodiment, the ethylene-vinyl acetate copolymer represents at least 30%, preferably at least 50%, preferably at least 75%, preferably also at least 80%, preferably also at least 90%, preferably also at least 95% of the weight of the binder.

The presence of ethylene-vinyl acetate copolymer thus ensures the electrode has adequate mechanical properties (elasticity, cohesion between the grains of the active material, and adherence to the current collector).

According to an embodiment, the percentage by weight of the vinyl acetate group represents 10-95%, preferably 50-95%, preferably also 70-90% of the weight of the ethylene-vinyl acetate copolymer.

The increase in the percentage by weight of the vinyl acetate group reinforces the adhesive character of the polymer. For a percentage by weight of the vinyl acetate group of less than 50% it would be necessary to increase the quantity of binder in order to obtain a satisfactory mechanical performance which would lead to a reduction in the volumic energy of the electrode.

According to an embodiment, the ethylene-vinyl acetate copolymer represents 0.25-1% by weight, preferably 0.25-0.8% by weight, preferably also 0.25-0.5% by weight of the weight of said paste.

Increasing the amount of binder leads to a loss of capacity, on the one hand, because the proportion of active material is decreased similarly, and on the other hand, because of the insulating character of the binder.

The ethylene-vinyl acetate copolymer(s) can be mixed with other chemical compounds forming part of the binder, such as:
one or more fluorinated polymers, such as polytetrafluoroethylene (PTFE);
one or more polymers with an acrylate function such as a polyacrylate, a poly(meth)acrylate, a styrene-acrylate copolymer, a styrene-maleic anhydride copolymer;
a compound of silane type. According to a preferred embodiment, the compound of silane type is glycidyloxypropyltrimethoxy-silane.

The binder comprises neither polystyrene nor butadiene copolymer.

According to an embodiment, the binder does not comprise styrene-acrylate copolymer.

The active material can be a nickel hydroxide containing at least one element chosen from Zn, Cd or Mg and at least one element chosen from Co, Mn, Al, Y, Ca, Sr, Zr, Cu. Preferably, this hydroxide has a spheroidal shape and has a granulometry comprised between 7 and 25 μm. The nickel hydroxide can preferably be covered with a coating based on cobalt hydroxide optionally partially oxidized, or combined with a conductive compound, principally constituted by Co(OH)₂. Other compounds such as Co, CoO, LiCoO₂, metal powders, carbons, ZnO, Y₂O₃, Yb₂O₃, Nb₂O₃, SrSO₄, Sr(OH)₂ can be added to the active material.

The binder is mixed with the nickel-hydroxide based compound. This mixture is deposited on a current collector to form the positive electrode of an alkaline battery.

Although a negative electrode of cadmium or metal hydride type can be produced with numerous families of binder, the positive electrode requires the use of a specific binder in order to ensure good cohesion of the active material. In fact, the positive and negative active materials are very different from the point of view of their developed surface and the form of the grains of active material. The grains of positive active material have a spheroidal morphology and an increased developed surface, of the order of 20 m²/g. The active material used for a cadmium or metal-hydride negative electrode has a developed surface approximately 100 times less increased than the active material of the positive electrode. The grains of negative active material have an acicular (needle-shaped) morphology.

The use of the binder according to the invention makes it possible to ensure good cohesion of the grains of positive active material.

The current collector can be an expanded nickel metal or a nickel plated steel strip, with a thickness comprised between 20 μm and 100 μm, a nickel plated steel strip shaped three-dimensionally, with a total thickness comprised between 100 and 700 μm. Preferably, the current collector is a two-dimensional support.

The conductor compound can be a cobalt compound. Preferably, it is chosen from the group comprising CoO, Co or Co(OH)₂.

The thickening agent can be a cellulosic polymer such as carboxymethylcellulose (CMC), hydroxypropylmethylcellulose (HPMC), hydroxypropylcellulose (HPC), hydroxymethylcellulose (HEC). It can also be a polymer of poly-acrylic acid (PAAC) or xanthan gum type.

According to an embodiment, conductive or non-conductive fibres can be added to the paste. Preferably, the quantity of fibres added is less than approximately 1.5% of the weight of the paste. Preferably, these are for example polypropylene polymer fibres, with a diameter comprised between 10 and 35 μm and with a length of less than 2 mm.

The active material can also be metallic cadmium, a hydrogen-fixing intermetallic compound of AB₅, AB₂ or ABₜ type with 3.2≦t≦3.5 or any negative active material usual in the art of alkaline batteries. The binder is mixed with the negative active material. This mixture is deposited on a current collector to form the negative electrode of an alkaline battery.

The electrochemical bundle is made by alternating positive and negative electrodes separated by a separator. The separator can be based on polyolefin fibres which are untreated, or treated with acrylic acid or sulphonated, or based on polyamide fibres.

The electrochemical bundle is introduced into the battery container.

The container is filled with electrolyte. The electrolyte impregnates the separators. The electrolyte is a strong base generally comprising KOH and/or NaOH and/or LiOH.

The alkaline battery thus obtained can be of nickel-cadmium or nickel-metal hydride type.

The battery can be of the cylindrical or prismatic type, open or sealed (valve-regulated), for portable or industrial applications (vehicle and emergency lighting in particular).

### EXAMPLES

A valve-regulated NiMH AA-format battery with a nominal capacity C of 1200 mAh is produced as follows.

A first reference positive electrode (P1) is produced with a paste having as composition by weight:

| | |
|---|---|
| Electrochemically-active material | 88.2% |
| Conductive material Co(OH)₂ | 10% |
| PTFE binder | 1% |
| Cellulose polymer CMC | 0.3% |
| Y₂O₃ | 0.5% |

The electrochemically-active material in powder form is constituted by a hydroxide based on nickel, and contains the following additives: cobalt and zinc. The viscosity of the paste is adjusted with water. The paste is introduced into a three-dimensional conductor support which is a nickel foam with a porosity of approximately 95%. Once the paste has been introduced into the support, the mixture is dried in order to remove the water from it, rolled then cut in order to obtain the electrode with the desired dimensions. The finished electrode has a porosity of 30% and a grammage of 16 g/dm².

A reference plasticized positive electrode (P2) is produced with a paste having as composition by weight:

| | |
|---|---|
| Electrochemically-active material | 87.5% |
| Conductive material Co(OH)₂ | 10% |
| Styrene acrylate binder | 0.7% |
| Cellulose polymer CMC | 0.3% |
| Polypropylene polymer fibre | 1.0% |
| Y₂O₃ | 0.5% |

The electrochemically-active material in powder form is constituted by a hydroxide based on nickel, and contains the following additives: cobalt and zinc. The viscosity of the paste is adjusted with water. The paste is deposited simultaneously on the two faces of a two-dimensional metal support (perforated nickel plated steel with a thickness of 50 μm) in a homogeneous manner. The whole is then dried in order to remove the water from it, then rolled to the desired thickness and cut in order to obtain a positive electrode. The finished electrode has a porosity of 30% and a grammage of 16 g/dm².

A reference plasticized positive electrode (P3) is produced with a paste having as composition by weight:

| | |
|---|---|
| Electrochemically-active material | 87.2% |
| Conductive material Co(OH)₂ | 10% |
| Styrene acrylate binder | 1% |
| Cellulose polymer CMC | 0.3% |
| Polypropylene polymer fibre | 1.0% |
| Y₂O₃ | 0.5% |

The electrochemically-active material in powder form is constituted by a hydroxide based on nickel, and contains the following additives: cobalt and zinc. The viscosity of the paste is adjusted with water. The paste is deposited simultaneously on the two faces of a two-dimensional metal support (perforated nickel plated steel with a thickness of 50 μm) in a homogeneous manner. The whole is then dried in order to remove the water from it, then rolled to the desired thickness and cut in order to obtain a positive electrode. The finished electrode has a porosity of 30% and a grammage of 16 g/dm².

A reference plasticized positive electrode (P4) is produced with a paste having as composition by weight:

| | |
|---|---|
| Electrochemically-active material | 88.0% |
| Conductive material Co(OH)₂ | 10% |
| EVA binder | 0.2% |
| Cellulose polymer CMC | 0.3% |
| Polypropylene polymer fibre | 1.0% |
| Y₂O₃ | 0.5% |

The electrochemically-active material in powder form is constituted by a hydroxide based on nickel, and contains the following additives: cobalt and zinc. The viscosity of the paste is adjusted with water. The paste is deposited simultaneously on the two faces of a two-dimensional metal support (perforated nickel plated steel with a thickness of 50 μm) in a homogeneous manner. The whole is then dried in order to remove the water from it, then rolled to the desired thickness and cut in order to obtain a positive electrode. The finished electrode has a porosity of 30% and a grammage of 16 g/dm².

A positive plasticized electrode of the invention (P5) is produced with a paste having as composition by weight:

| | |
|---|---|
| Electrochemically-active material | 87.5% |
| Conductive material Co(OH)₂ | 10% |
| EVA binder | 0.7% |
| Cellulose polymer CMC | 0.3% |
| Polypropylene polymer fibre | 1.0% |
| Y₂O₃ | 0.5% |

The electrochemically-active material in powder form is constituted by a hydroxide based on nickel, and containing the following additives: cobalt and zinc. The viscosity of the paste is adjusted with water. The paste is deposited simultaneously on the two faces of a two-dimensional metal support (perforated nickel plated steel with a thickness of 50 μm) in a homogeneous manner. The whole is then dried in order to remove the water from it, then rolled to the desired thickness and cut in order to obtain a positive electrode. The finished electrode has a porosity of 30% and a grammage of 16 g/dm².

A positive plasticized electrode according to the invention (P6) is produced with a paste having as composition by weight:

| | |
|---|---|
| Electrochemically-active material | 87.2% |
| Conductive material Co(OH)₂ | 10% |
| EVA binder | 1% |
| Cellulose polymer CMC | 0.3% |
| Polypropylene polymer fibre | 1.0% |
| Y₂O₃ | 0.5% |

The electrochemically-active material in powder form is constituted by a hydroxide based on nickel, and contains the following additives: cobalt and zinc. The viscosity of the paste is adjusted with water. The paste is deposited simultaneously on the two faces of a two-dimensional metal support (perforated nickel plated steel with a thickness of 50 μm) in a homogeneous manner. The whole is then dried in order to remove the water from it, then rolled to the desired thickness and cut in order to obtain a positive electrode. The finished electrode has a porosity of 30% and a grammage of 16 g/dm².

A positive electrode according to the invention (P7) is produced with a paste having as composition by weight:

| | |
|---|---|
| Electrochemically-active material | 86.2% |
| Conductive material Co(OH)₂ | 10% |
| EVA binder | 2% |
| Cellulose polymer CMC | 0.3% |
| Polypropylene polymer fibre | 1.0% |
| Y₂O₃ | 0.5% |

The electrochemically-active material in powder form is constituted by a hydroxide based on nickel, and contains the following additives: cobalt and zinc. The viscosity of the paste is adjusted with water. The paste is deposited simultaneously on the two faces of a two-dimensional metal support (perforated nickel plated steel with a thickness of 50 μm) in a homogeneous manner. The whole is then dried in order to remove the water from it, then rolled to the desired thickness and cut in order to obtain a positive electrode. The finished electrode has a porosity of 30% and a grammage of 16 g/dm².

A test of mechanical performance of the electrodes is carried out in the following manner: Each electrode is weighed, then dropped from a height of 50 cm onto a flat surface. The drop is repeated 10 times. Then the electrode is weighed again. The result of the test is expressed as the ratio of the initial mass less the final mass with respect to the initial mass. An electrode is more solid the lower this ratio is and the mechanical performance of the electrode is considered to be satisfactory when this ratio is less than 0.5%. The results of the mechanical test are shown in Table 1:

TABLE 1

| | Electrode | | | | | | |
|---|---|---|---|---|---|---|---|
| | P1 | P2 | P3 | P4 | P5 | P6 | P7 |
| Support | foam | strip | strip | strip | strip | strip | strip |
| PTFE | 1% | — | — | — | — | — | — |
| Styrene- | — | 0.7% | 1% | — | — | — | — |
| acrylate | | | | | | | |
| EVA | — | — | — | 0.2% | 0.7% | 1% | 2% |
| Test (%) | 0.21 | 0.67 | 0.41 | 0.83 | 0.34 | 0.26 | 0.15 |

According to table 1, the reduction in the amount of styrene-acrylate from 1% (P3) to 0.7% (P2) leads to a significant degradation in the mechanical performance of the positive plasticized electrode while with 0.7% EVA (P5), the mechanical performance remains satisfactory. Thus, the use of EVA allows a reduction in the amount of binder in the electrode of 30% without degradation of the mechanical performance. For an amount of EVA less than approximately 0.25% (P4), the electrode becomes too fragile to be spiralled without observing losses of active material.

A valve-regulated NiMH AA-format battery, of which the positive electrode is the limiting electrode, and the nominal capacity of which is 1200 mAh, is constituted by the positive electrodes described above and by a negative electrode of known type which has as electrochemically-active material an intermetallic compound capable of forming a hydride once charged. The positive electrode is placed alongside a negative electrode from which it is isolated by a polypropylene non-woven separator in order to form the electrochemical bundle. The bundle thus spirally wound is inserted into a small metal container and impregnated with an alkaline electrolyte which is an aqueous alkaline solution constituted by a mixture of 7.5N potassium hydroxide KOH, 0.4N sodium hydroxide NaOH and 0.5N lithium hydroxide LiOH in order to constitute the batteries A, B, C, D, E, F, G. The composition of each of the batteries is described in Table 2.

TABLE 2

| Reference | A | B | C | D | E | F | G |
|---|---|---|---|---|---|---|---|
| Positive | P1 | P2 | P3 | P4 | P5 | P6 | P7 |
| electrode | | | | | | | |
| Negative | N1 | N1 | N1 | N1 | N1 | N1 | N1 |
| electrode | | | | | | | |

### Electrochemical Performance:

After resting for 48 hours at ambient temperature, an electrical forming of the batteries is carried out under the following conditions:

### Cycle 1:

Rest 2 h at 80° C.;
Charge at 0.025 Ic for 8 h at 80° C., where Ic is the current necessary for discharging the nominal capacity C of the battery in 1 h;
Rest 2 h at 20° C.;
Charge 3 h 0.33 Ic;
Discharge at 0.2 Ic to a voltage of 1V.

### Cycles 2 to 10:

Charge 16 h at a current of 0.1 Ic;
Discharge at 0.2 Ic to a voltage of 1V.

### Cycle 11:

Charge 72 minutes at a current of Ic;
Discharge at Ic to a voltage of 1V.

After the initial 11 cycles, half of the batteries undergo the cycle test 1 and the other half the cycle test 2.

### Test 1:

Charge for 66 minutes at a current of C at 20° C.;
Discharge at Ic at 20° C. to a voltage of 1V.

### Test 2:

T=40° C.

### Cycle Conditions:

Charge 66 minutes C at 40° C.;
Discharge at Ic at 40° C. to a voltage of 1V.

The life of the batteries is determined by the number of cycles carried out until the capacity of the battery becomes less than 80% of its nominal capacity.

The results of the electrical tests are shown in Table 3:

TABLE 3

| Reference | A | B | C | D | E | F | G |
|---|---|---|---|---|---|---|---|
| Positive electrode | P1 | P2 | P3 | P4 | P5 | P6 | P7 |
| Negative electrode | N1 | N1 | N1 | N1 | N1 | N1 | N1 |
| Output of the positive | 253 | 225 | 247 | 207 | 250 | 254 | 241 |
| electrode at cycle 10 | | | | | | | |
| (mAh/g) | | | | | | | |
| Output of the positive | 244 | 218 | 242 | 198 | 240 | 242 | 206 |
| electrode at cycle 11 | | | | | | | |
| (mAh/g) | | | | | | | |
| Life span in Test 1 | 734 | 340 | 725 | 223 | 735 | 728 | 740 |
| Life span in Test 2 | 516 | 117 | 253 | 187 | 423 | 256 | 156 |

According to the results indicated in Table 3, the use of 0.7% styrene-acrylate in the positive plasticized electrode (Ref: B) probably degrades the initial electric performances due to the loss of material of the electrode.

Similarly, when the EVA amount is less than 0.25% (Ref: D), the mechanical performance is insufficient in order to obtain satisfactory performances and a life span.

On the other hand, 0.7% EVA (Ref: E), the initial electrical performances are equivalent to those obtained with a foam electrode (Ref: A) and the life cycle at 40° C. is markedly improved: from 117 cycles with 0.7% styrene acrylate (Ref: B) to 423 cycles with 0.7% EVA (Ref: E).

1. A positive plasticized electrode comprising a conductive metal support and a paste comprising an electro-chemically-active material and a binder;
the binder comprising at least an ethylene-vinyl acetate copolymer representing at least about 0.25%-1% by weight of the weight of said paste.
the binder comprising neither polystyrene nor butadiene copolymer.

2. Electrode according to claim 1, in which the ethylene-vinyl acetate copolymer represents at least 30% of the weight of the binder.

3. Electrode according to claim 1, in which the percentage by weight of the vinyl acetate group represents 10-95% of the weight of the ethylene vinyl acetate copolymer.

4. Electrode according to claim 1, in which the ethylene-vinyl acetate copolymer represents 0.25-0.8% by weight of the weight of said paste.

5. Electrode according to claim 1, in which the binder contains a fluorinated polymer.

6. Electrode according to claim 5, in which the fluorinate polymer is polytetrafluoroethylene.

7. Electrode according to claim 1, in which the binder contains a polymer with an acrylate function.

8. Electrode according to claim 7, in which the polymer with an acrylate function is chosen in the group comprising a styrene-acrylate copolymer, a poly(meth)acrylate, a styrene-maleic anhydride copolymer.

9. Electrode according to claim 1, in which the binder contains a compound of silane type.

10. Electrode according to claim 1, also comprising fibres.

11. Electrode according to claim 10, in which the fibres are polypropylene fibres.

12. Electrode according to claim 10, in which the quantity of fibres added is less than approximately 1.5% of the weight of the paste.

13. Electrode according to claim 1, in which the conductive metal support is two-dimensional.

14. Electrode according to claim 1, in which the electrode is the positive electrode of an alkaline battery.

15. Electrode according to claim 14, in which the electrochemically-active material is a compound based on nickel hydroxide.

16. Electrode according to claim 1, which is the negative electrode of an alkaline electrolyte battery.

17. Alkaline electrolyte battery comprising an electrode according to claim 1.

18. Electrode comprising a conductive metal support and a paste comprising an electrochemically-active material and a binder;
the binder comprising at least an ethylene-vinyl acetate copolymer representing about 0.25-1% by weight of the weight of said paste;
the ethylene-vinyl acetate copolymer representing at least 80% of the weight of the binder.
